(19) United States
(12) Patent Application Publication
(10) Pub. No.: US 2010/0199927 A1
(43) Pub. Date: Aug. 12, 2010

(54) TACTICAL VEST FOR CANINES

(75) Inventors: Tyler A. CIGARD, Fayetteville, NC (US); Elias L. GONZALEZ, Fayetteville, NC (US)

Correspondence Address: Husch Blackwell Sanders LLP, 190 Carondelet Plaza, Suite 600, St. Louis, MO, 63105, US

(73) Assignee: EAGLE INDUSTRIES UNLIMITED, INC., Fenton, MO (US)

(21) Appl. No.: 12/369,529

(22) Filed: Feb. 11, 2009

(51) Int. Cl. A01K 13/00

(52) U.S. Cl. 119/850

(57) ABSTRACT

A vest for canines or other animals is provided. The vest includes a jacket that includes a top member and a bottom member with portions releasably secured to one another. One or more expander panels can be provided to be releasably secured between portions of the jacket to selectively change the girth dimension of the jacket. The vest may also be provided with devices for attaching various auxiliary items to the vest in a releasable manner. Carriage devices can also be provided for facilitating handling of the dog or other animal by its handler or lift devices. Such carriage devices can include loops adapted for attachment to shoulder straps, gripping by a handler's hands or by a lift device. Redundant securement devices are provided to ensure portions of the jacket do not separate unintentionally. The jacket is adapted for use with a tail harness and the collar is adjustable to prevent the vest from slipping off the canine or other animal.

### BACKGROUND OF INVENTION

Dogs (canines) have long been used for law enforcement and military purposes. Typical roles for such animals include protection of personnel, search and rescue, pursuit of people of interest, tracking, smell detection of items of interest, e.g., drugs and explosives, intimidation and other civil and criminal applications. The roles of dogs in law enforcement and military activities has expanded over the years. Originally, a dog was simply equipped with a collar to which a leash could be attached for a handler to control and restrain the dog since the area of use was relatively small and local. Today, dogs are transported to and from and are used in large areas of investigation and in tactical theaters of operation including areas involving hostilities. Vests have been utilized by dogs to improve their transportability including ingress and egress from airplanes and/or helicopters. Vests have also been supplied to provide protection for the dog in both combat zones and in law enforcement applications, or to assist the handler in handling and managing the dogs. Vests can be used to allow a dog to carry supplies and/or equipment, to be hoisted and/or carried by a handler, or even to parachute with a handler into the area of investigation. Vests can also be used with armor elements to provide additional protection for the dog, particularly in combat zones. While such vests have provided limited advances in dog management, these vests have been found to be deficient for the expanded roles of dogs in these environments.

There is thus, a need for an improved vest to provide for the management of a dog for expanded roles.

### SUMMARY OF THE INVENTION

The present invention relates to a tactical vest for use on a canine or other animals. The vest includes a plurality of panel portions including an upper panel portion, lower panel portion and a pair of side panel portions which when assembled, form a jacket having a neck opening and a tail opening. The jacket substantially surrounds a longitudinally extending body receiving cavity. At least one continuous closure device extends in a direction between the neck opening and the tail opening and has two elongate portions adapted for selective engagement with one another. One of the portions can be connected to one panel and another of the portions can be connected to an adjacent panel and when not engaged with one another provide an elongate side opening for putting the vest on or removing of the vest from a canine or other animal.

An expander panel may be included which has complimentary closure device portions which cooperate with portions of the other closure device to permit the installation or removal of the expander panel between the two adjacent jacket portions to permit expansion or contraction of the girth size of the jacket to accommodate weight gain or weight loss of a dog or other animal or to permit the vest to be custom fit to different dogs or different animals.

Additional securement devices may be provided on the jacket to bridge the closure device to additionally secure together the jacket portions joined by the closure device.

The vest may also include one or more attachment devices adapted for mounting auxiliary items to the vest for carriage thereof.

### DETAILED DESCRIPTION OF THE DRAWINGS

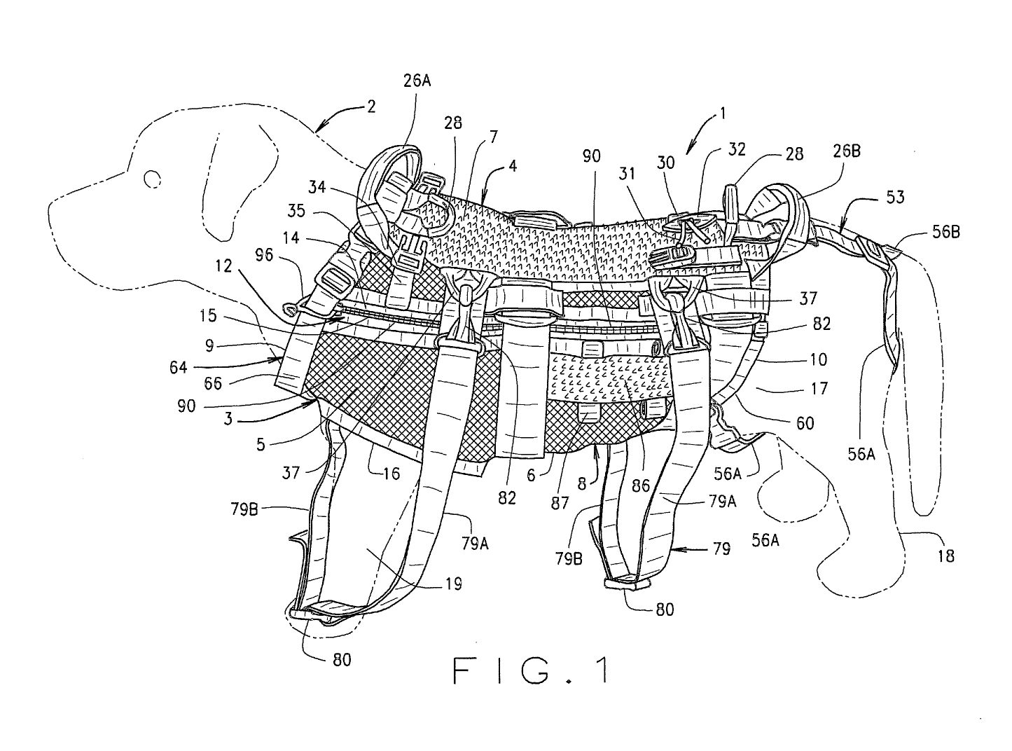

FIG. 1 is a side perspective view of a tactical vest as mounted on a canine constructed in accordance with the teachings of the present invention.

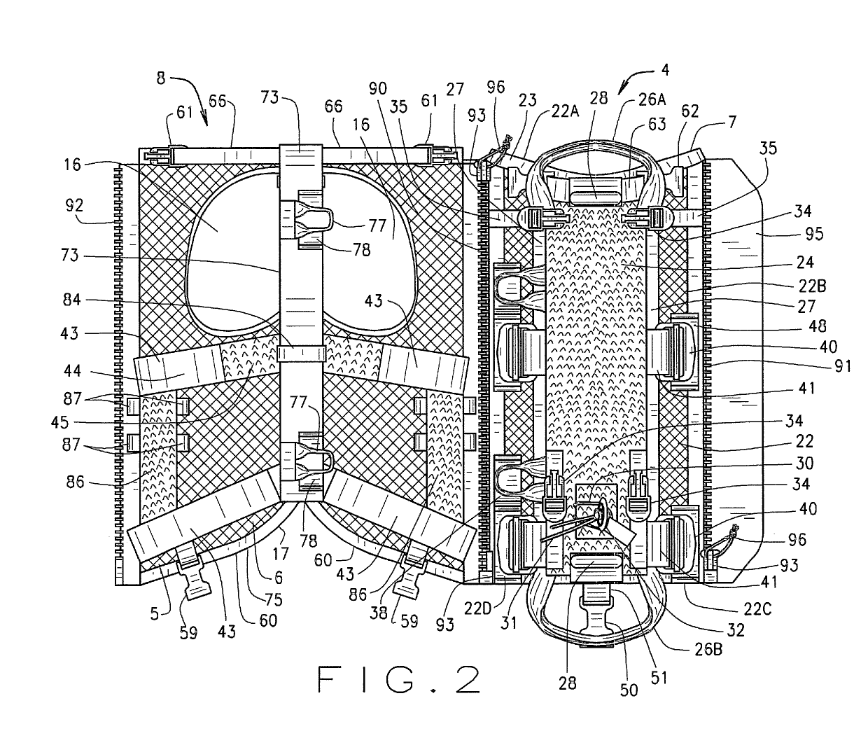

FIG. 2 is a top plan view of the vest of FIG. 1 with the vest being in a laid out flat configuration.

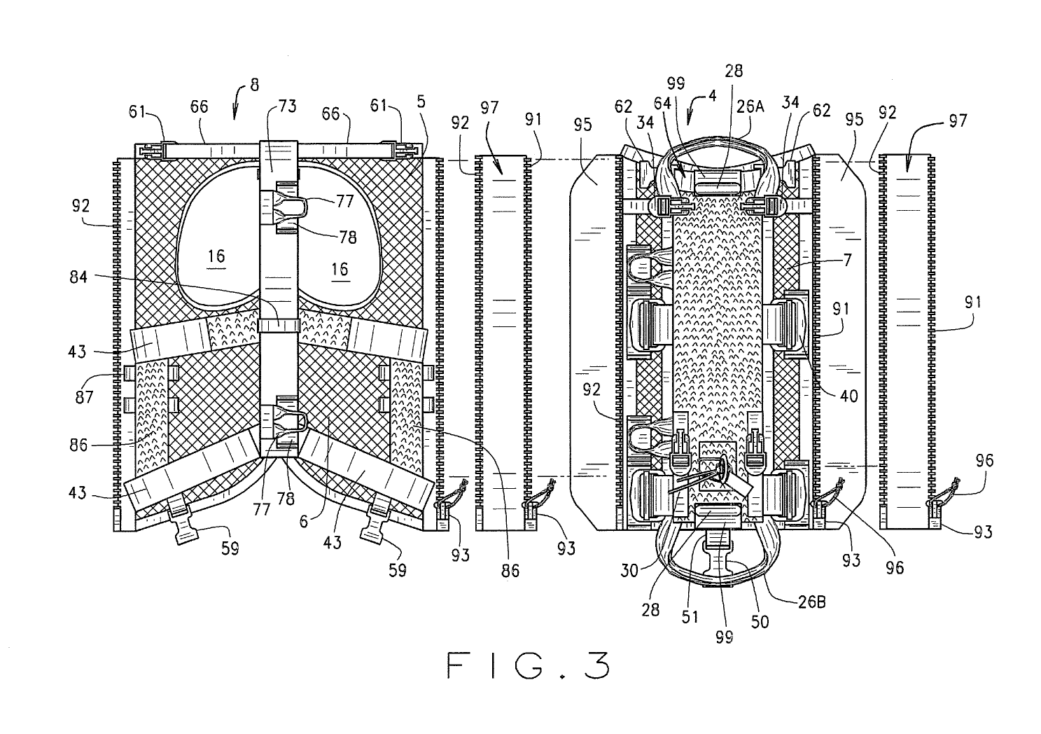

FIG. 3 is a plan view similar to FIG. 2 but including a pair of expander panels.

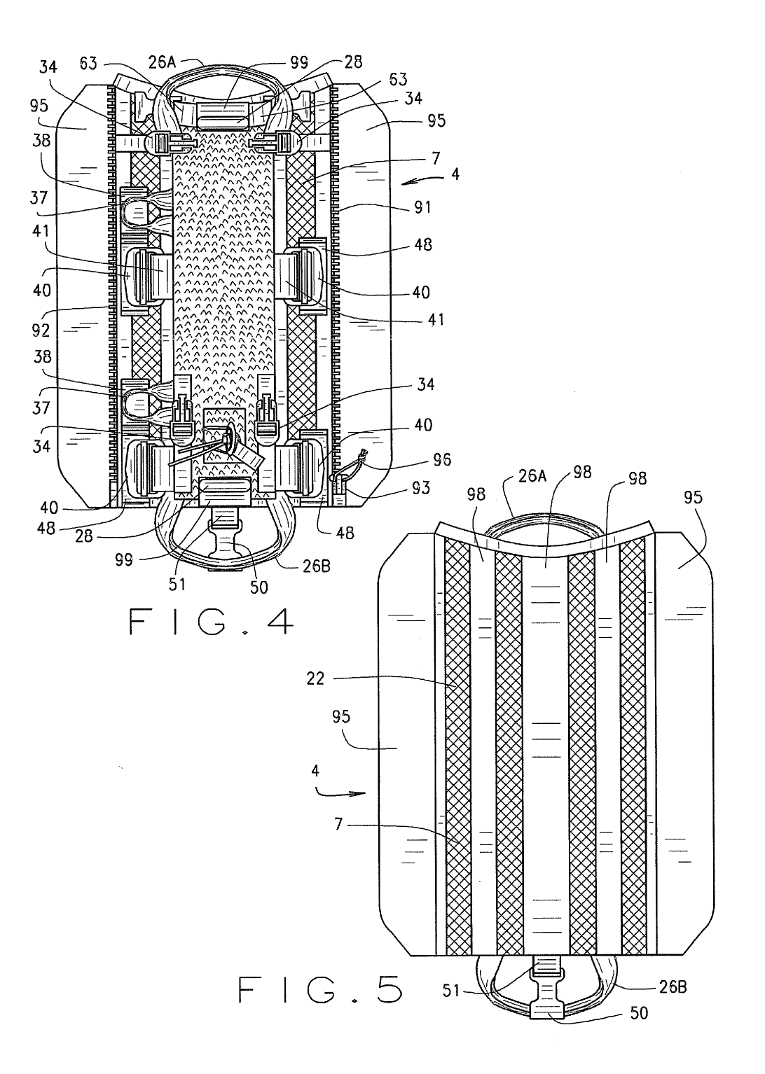

FIG. 4 is an outside plan view of a top portion of the vest of FIG. 1.

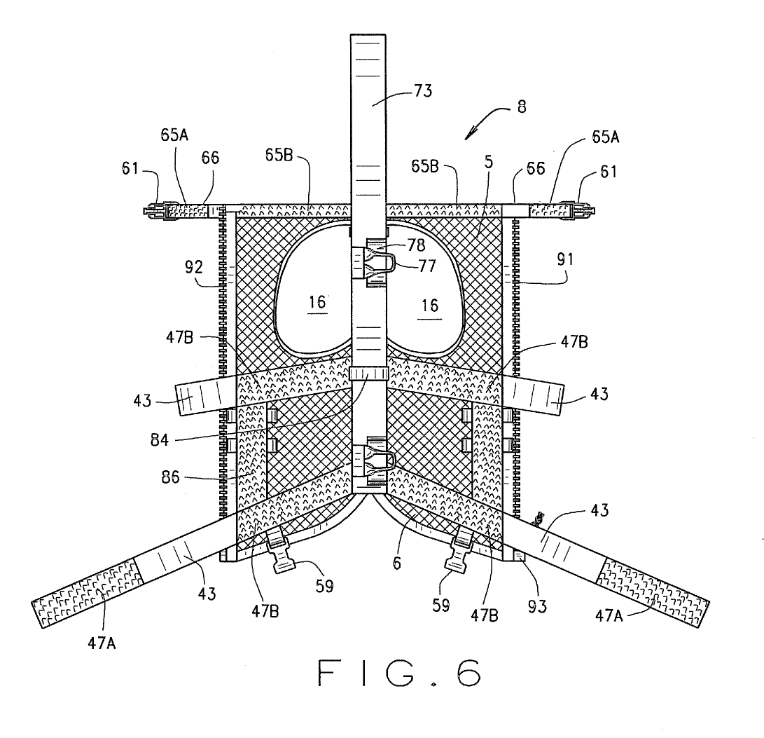

FIG. 5 is an inside plan view of the top portion of the vest of FIG. 4.

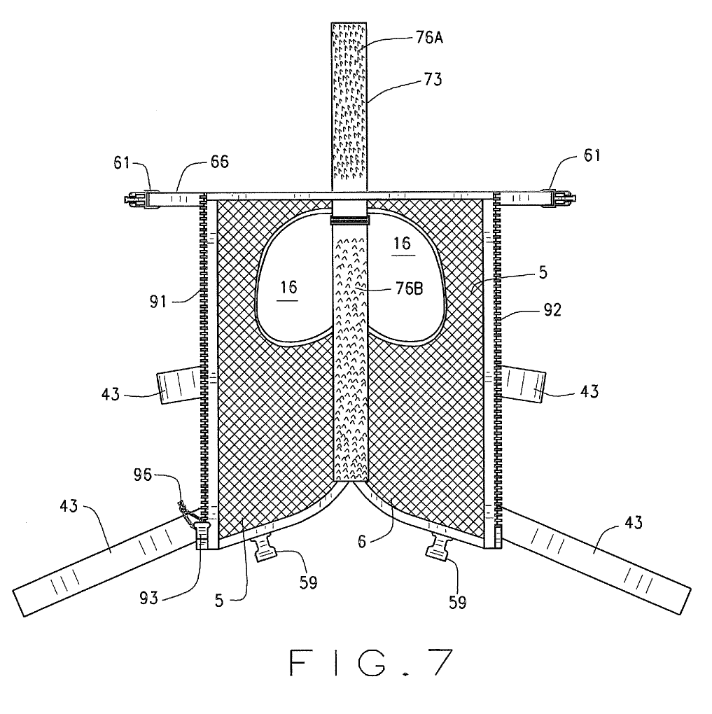

FIG. 6 is an outside plan view of the bottom portion of the vest of FIG. 1 with strap portions disconnected.

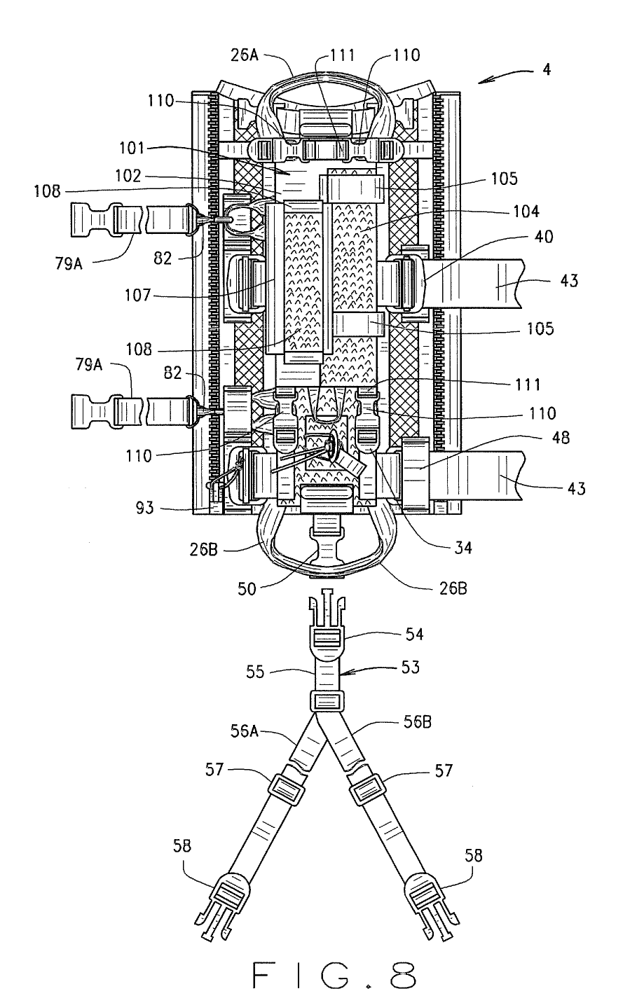

FIG. 7 is an inside plan view of the bottom portion of the vest of FIG. 6.

FIG. 8 is an outside plan view of the top portion of the vest of FIG. 1 shown with certain accessory items mounted thereto.

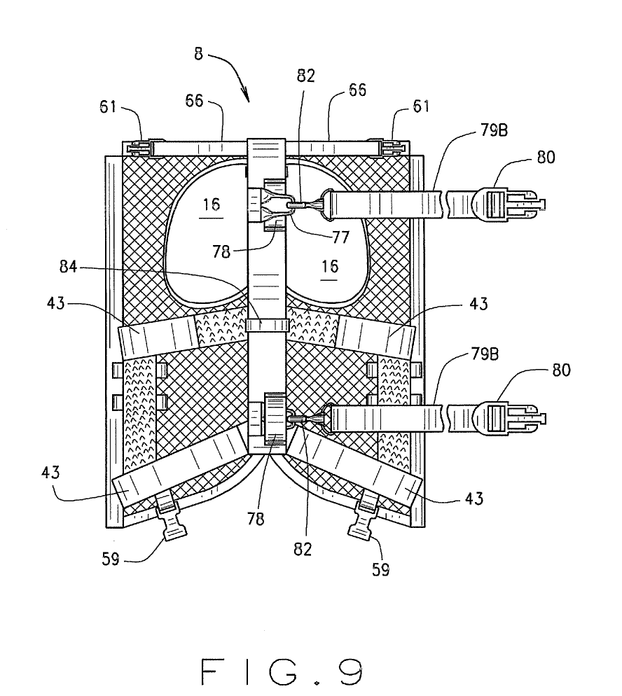

FIG. 9 is an outside plan view of the bottom portion of the vest of FIG. 1 shown with certain accessory items attached thereto.

Like numbers throughout the various figures designate like or similar parts and/or construction.

### DETAILED DESCRIPTION OF THE INVENTION

The reference numeral 1 designates generally a vest for use on a canine 2 such as a dog. Although the following disclosure is directed to use of the present vest on a canine, it is recognized and anticipated that the present vest can be used on a wide variety of other animals for similar and other applications. The vest 1 includes a jacket 3 comprised of a top member 4 and a bottom member 8 which include a plurality of panels including opposed side panels 5, lower panel 6 and upper panel 7. End portions of the panels 5, 6, 7 define a neck opening 9 and a tail opening 10. At least one continuous closure device 12 is provided between two of the panels 5, 6, 7 and has at least two elongate portions 14, 15 that are selectively interengagable with one another to form a positive mechanical connection along their length. When the closure device 12 is closed, i.e., the portions 14, 15 are connected together, the panels 5, 6, 7 define a body receiving cavity 16 and provides for releaseable securement of the vest 1 to the dog 2. When the closure 12 is open, i.e., the portions 14, 15 are disconnected, the vest 1 is in a configuration for mounting the vest 1 on and removing the vest from the dog 2. The closure device 12 extends from the neck opening 9 to the tail opening 10 generally longitudinally of the jacket 3. At least one front leg opening 16 and at least one rear leg opening 17 are provided with a portion of the tail opening 10 also providing the opening 17 for the rear legs 18. The front legs 19 can extend through the front leg opening 16. As used herein, words denoting location or direction are to be construed as if the vest 1 were on a dog 2 with the dog in a normal upright orientation.

The jacket 3 includes the top member 4. As best seen in FIGS. 2 and 3, the outside portions of the top member 4 are shown. The top member 4 includes the upper panel portion 7 having a mesh panel 22 that is bounded by edges 22A-D. Preferably, the edge portions 22A-D include a sewn on fabric tape 23 which prevents unraveling of the edge portions. An attachment device 24 is attached to the panel 22 as by sewing. The attachment device 24 may be of any suitable size or shape and preferably includes either a panel of hooks or a panel of loops as part of a hook and loop fastener system. In the illustrated structure, the attachment device 24 extends between the front and rear edges 22A, 22C while leaving some of the mesh panel 22 exposed adjacent the edges 22B, D. Carriage devices are also shown as being provided. A pair of handles 26A, B is provided and are sized for receipt therethrough of a portion of a human's hand. Handle 26A is positioned adjacent the neck opening 9 and the handle 26B is positioned adjacent the tail opening 10. The provision of handles permits a handler to pick up the dog on which the vest 1 is mounted on opposite sides of the dog's center of gravity to permit the handler to lift the dog and negotiate obstacles such as walls and windows. The handles 26A, B may be made from a tubular webbing and are preferably formed from a continuous piece of tubing providing side portions 27 extending along the edges of the attachment device 24. The side portions 27 provide reinforcement for the upper panel 7. The handles 26A, B may be provided with internal stiffener members such as polymeric tubing to increase the rigidity and hand engagement area of the portions engaging a handler's hands. Another form of carriage device can be provided. A pair of loops 28 is also secured to the upper panel 7 in a position preferably adjacent opposite ends of the upper panel 7 adjacent openings 9, 10. The loops 28 may be of a sewn webbing or tubing material and may be reinforced at their center attached section. The loops 28 are positioned on the upper panel 7 such that they are over the spine of the dog 2 when the vest 1 is mounted thereon for use and are preferably positioned on opposite sides of a dog's center of gravity. The loops 28 may be used in conjunction with a hoist device or a tether for lifting, restraining or supporting the dog 2.

In the illustrated structure, the top member 4 is also provided with a device for removably securing an accessory or auxiliary device such as a strobe light or flashlight to the vest 1. As shown, the attachment device 30 includes an elastic cord 31 having a slide type lock device 32 for increasing or decreasing the size of the opening within the loop formed by the cord 31. The device 30 may be positioned at any suitable location on the upper panel 7 and is shown adjacent the tail opening 10. It is to be also understood that such a device may be secured to any of the panels 5, 6, 7 at any suitable location for the accessory device to be carried. The top member 4 may also be provided with additional means for attaching accessories. As shown, such attachment means include buckle portions 34 secured to the upper panel portion 7 as with sewn straps 35. The buckle portions 34 may be of any suitable type and are shown as the male half of a side release buckle. An accessory may be provided with the other half of a buckle portion for cooperative interengagement with a respective buckle portion 34.

In the illustrated structure, the top member 4 is provided with other attachment devices. As seen in FIG. 1 and FIG. 2, connectors such as loops 37 are attached to the upper panel 7 and may be made of a flat or tubular webbing material having the central portion thickened and made more rigid as by sewing the two opposite side edge portions together. Keepers 38 may also be provided and attached to the upper panel portion 7. The keepers 38 may be flat elastic material sewn to the upper panel portion 7 providing an open sided pocket into which the loops 37 may be placed when not in use to releasably secure them in a position that will preclude them from catching on objects. The pockets formed by the keepers 38 may be closed on one side or open on both sides. Other attachment or securement devices include, in the illustrated structure, a plurality of securement devices in the form of D-buckles 40 having a middle lock slider although other types of buckles can be used which are adapted for use with a strap device to accommodate adjustable length. The buckles 40 are secured to the upper panel 7 as with sewn on webbing 41 and couple the webbing 40 and top member 4 to the strap 43 and bottom member 8 thereby forming a strap device that bridges a closure or attachment device 90 described below. The buckles 40 are used in conjunction with girth straps 43 secured to the bottom member 8 to either or both of the side panels 5 and lower panel 6. In a preferred embodiment, each of the girth straps 43 has a free end portion 44 that is releasably attachable to an attached portion 45 as with hook and loop fastener elements 47A, B with the loop fastener element 47A being secured to the portion 45 and the hook fastener element 47B being secured to the portion 44 (FIG. 6). The free end portion 44 will pass through the opening in a respective buckle 40 and around the slider 46 which with strap tension will lock the respective girth strap at a pre-selected length in the respective buckle 40. The free end 44 can then be releasably attached to the attached end 45 through interengagement of portions of the hook and loop fastener elements 47A, B forming an adjustable length loop. Keepers 48 like the keepers 38 may also be provided for each of the buckles 40 to constrain their movement and limit availability of the openings in the buckles 40 for snagging. As seen in FIG. 2, the straps 43 adjacent the middle portion of the lower panel 6 intermediate the tail and neck openings 9, 10 are slightly inclined from vertical toward the rear while the rear straps 43 adjacent the tail opening 10 are oriented at a greater angle from vertical adjacent the tail opening 10.

Another attachment device is provided and is best seen in FIG. 2. It includes a buckle portion 50 attached adjacent the tail opening 10 on the upper panel 7. The attachment of the buckle portion 50 may be through the use of sewn webbing 51. A saddle strap tail harness assembly 53, as best seen in FIG. 8, is provided. The harness assembly 53 includes a buckle portion 54. The buckle portion 54 is adapted for releasable connection to the buckle portion 50 to attach the harness assembly 53 in a releasable manner to the top member 4 and hence the jacket 3. In the illustrated structure, the harness assembly 53 is Y-shaped having a tongue member 55 attached to the buckle portion 54 and has two branches 56A, B that are adjustable in length via ladder lock portions of the buckle portions 58 with excess strap being secured via a respective tri glide type buckle 57. The buckle portions 58 are provided at the respective free ends of the branches 56A, B for attachment to complimentary buckle portions 59 preferably secured as with sewn webbing to the bottom member 8 and preferably the side panels 5 adjacent the tail opening 10. The buckle portions 50, 54, 58, 59 are parts of side release buckles preferably having at least one ladder lock end. The harness assembly 53 when attached, prevents excessive forward movement of the vest 1 on the dog 2 by engagement of the strap portions 56A, B with the legs 18 and rear quarters of the dog. The strap portions 56A, B and edge portion 60 of the side panels 5 define the rear leg receiving openings 17 for the dog 2.

An adjustable size collar assembly 64 (FIGS. 1, 3) is provided at the neck opening 9. In the illustrated structure, the collar assembly 64 includes strap members 66 secured to the side panels 5 and lower panel 6 at the neck opening 9 and has adjustable length as by using hook and loop fastener elements on portions of the straps 66. As shown, each strap 66 has a free end portion that permits adjustment of the length of the respective strap 66. The collar assembly 64 includes buckle portions 61 movably mounted on a respective strap 66. The buckle portions 61 are releasably securable to complimentary buckle portions 62 secured to the upper panel portion 7 as with sewn webbing 63. Each buckle portion 61 is releasably connected to its complimentary buckle portion 62 to form a coupling device for releasably connecting portions of the strap 66 together and forming a collar around the neck opening 61. The size of the neck opening 9 and collar assembly 64 is set by the length of the straps 66 which can be adjusted through the use of hook and loop fastener elements 65A, 65B (FIG. 6) secured to each of straps 66 which form a loop in each strap when connected. The buckle portions 61, 62 are preferably part of a side release buckle having a ladder lock end for connection to a strap 66. The illustrated collar assembly 64 serves as a securement or attachment device bridging portions of the closure device 90 described below and providing redundant securement of portions of the jacket 3 together.

The jacket 3 as best seen in FIG. 2 includes the bottom member 8 including the lower panel portion 6 and the side panel portions 5. It may be made of an open weave mesh material to provide for ventilation and flexibility. The bottom member 8 has the straps 66 secured thereto defining the lower portion of the neck opening 9. The bottom member 8 defines portions of at least one front leg opening 16 and preferably two front leg openings 16 for the dog 2. As seen in FIG. 2, the openings 16 are separated by a strap 73 that is sewn to the mesh panel 74. The strap 73 extends longitudinally between the neck opening 9 and tail opening 10. The strap 73 may be adjustable in length through the use of hook and loop closure elements 76A, B (FIG. 7) secured to the strap 73 to provide for adjustment of the longitudinal size of the openings 16. The edges of the mesh panel 74 can be bound with binding tape 75 as by sewing. The binding tape 75 can be used to prevent raveling of the edges of the mesh of panel 74. The bottom member 8 is shown as being provided with loop members 77 (FIGS. 6, 9) secured thereto as for example by being sewn to the strap 73. Elastic keepers 78, like keepers 38, 48, may also be provided to selectively enclose the open ends of the loops 77 when not in use. The loops 77 may be used in combination with the loops 37 for the attachment of shoulder straps 79 through the use of safety type hooks 82 (FIG. 9) to the jacket 3 to allow a handler to carry the dog on the handler's back or front. The shoulder straps 79 are shown as having strap portions 79A, B connected by a respective buckle 80. The buckle 80 is preferably a side release two piece buckle that permits the strap portions 79A, B to be selectively separated. The shoulder straps 79 may be adjustable in length by the provision of the buckle 80 with a ladder type strap locking portion. The free ends of the shoulder straps 79 may each be provided with a respective hook 82 for releasable attachment to a respective loop 77, 37. This can be seen in FIGS. 1, 9.

A loop 84 is provided on the bottom member 8 and is sized to receive therethrough a lead connected to a collar (not shown) for use by a handler in controlling movement of the dog. The loop 84 is positioned about mid-point between the neck opening 9 and tail opening 10 or to the rear thereof. The loop 84 will reduce the chance that the lead will become entangled in the dog's legs during use by directing the lead to stay between the dog's rear legs 18. The bottom member 8 may also be provided with attachment devices 86 (FIG. 3) preferably on opposite sides thereof and preferably located on the side panel portions 5. Attachment devices 86 can each be a hook or loop member sewn to the bottom member 8 and may be positioned at any suitable location along the length of the bottom member 8. In the illustrated structure, the attachment devices 86 are shown as being secured to a rear portion of the bottom member 8. Attachment devices 86 may be utilized for releasably securing an identification member (not shown) or any other suitable item. The attachment devices 86 may also include loops 87. The illustrated structure shows four loops on each attachment device 86 with the loops being positioned in aligned pairs. The loops 87 may be used to releasably mount lights, chemical light sticks and the like on the vest 1. Preferably the loops 87 are made of an elastic material.

In a preferred embodiment, the bottom member 8 is releasably securable to the top member 4 in a manner that permits the mounting of the vest 1 onto a dog 2 or other animal. At least one attachment or closure device 90 (FIGS. 1, 2) is provided and extends longitudinally of the vest 1 between the neck opening 9 and the tail opening 10 to selectively provide a side opening to permit wrapping of the jacket 3 about the dog and allow insertion of the dog's front legs 19 into the openings 16. In the illustrated structure, there is a pair of attachment devices 90, one on each side of the top member 4 and the bottom member 8. The attachment devices 90 are selectively separable to provide an ingress and egress opening for the dog 2. In the illustrated structure, the attachment devices 90 are in the form of toothed, preferably not coiled, zippers having toothed side runs 91, 92 with each side run 91 having the zipper pull 93 thereon. The zipper runs 91, 92 are each secured to a respective side portion of either the bottom member 8 or the top member 4. Securement of the side runs 91, 92 can be by any suitable means as, for example, stitching.

Preferably, there is a single zipper used in the unexpanded vest along each side thereof. In the illustrated structure, flaps 95 are provided and can be secured to either the upper panel portion 7 or the bottom member 8 to underlie the zipper side runs 91, 92 to provide protection for the dog from direct contact with an attachment or closure device (zipper) 90. In the illustrated structure, the flaps 95 are secured to and extend from opposite edge portions of the upper panel portion 7. Preferably, the zipper pulls 93 are of a locking type and are provided with a secondary lock device 96 (FIGS. 1 and 2) which will secure the zipper pull in a zipper closed position. As shown, the lock device 96 includes a loop made with tied cord extending through an opening in the zipper pull 93. The loop of lock 96 can receive therethrough a portion of the collar strap 60 or 63 which will secure the respective zipper pull 93 in a zipper closed position. See FIG. 1. In the illustrated structure, both zipper pulls 93 are in a closed configuration when adjacent the neck opening 9. However, the zipper pull 93 could be in a closed position adjacent the tail opening 10 and could be locked in place using the strap 43. The separable sections of the vest 1, i.e. the top member 4 and the bottom member 8, provide for interchangeability of components and if one component becomes worn or damaged, replacement of both components is not required. Only the damaged portion need be replaced.

FIG. 3 illustrates an option for use with the jacket 3. As shown, auxiliary expander panels 97 are provided. Along each side of a panel 97, there is provided a complimentary zipper side run 91 or 92 which will selectively interengage with a respective side run 92, 91 to provide a positive mechanical connection whereby a panel 97 can be inserted between zipper halves along a side of the jacket 3 to selectively increase the girth dimension of the jacket 3. As shown, the opposite sides of panels 97 are generally parallel but it is to be understood that they could be tapered or contoured in width and shape. Thus, when a dog gains or looses weight, one or more panels 97 may be inserted or removed to accommodate a change in girth. Preferably, a pair of panels 97 is used simultaneously to provide symmetry.

The above description and the Figures are directed to a preferred embodiment of the present invention and utilizes a pair of closure devices 90 one on each of opposite sides of the top member 4. In an alternate embodiment, a single closure device 90 can be provided and would be preferably positioned in the upper panel 7 although it could be positioned in the lower panel 6 preferably generally centrally thereof. The closure device 90 would preferably extend between the neck and tail openings 9, 10. Such a construction would also provide symmetry in fit of the jacket 3 on a canine 2 and also allow use of an expander panel 97 and flap 95 while still providing fit symmetry. The below described accessory device 101 as well as other attachment means, as described, can also be used.

Reinforcements may be added to the vest at high stress locations or at locations components are sewn to the mesh. As seen in FIG. 5, reinforcing strips 98 are sewn on the inside surface of the upper panel portion 7. Additionally, reinforcements 99 may be added to reinforce the attachment of the loops 28 to the upper panel portion 7.

FIG. 8 illustrates the top member 4 with an accessory device 101 releasably mounted thereto. The accessory device 101 includes a mount panel 102 having a hook and loop fastener element on the inside face cooperatively interengageable with the hook or loop member 24 of the top member 4. The illustrated device 101 is adapted for mounting a camera (not shown) to the vest 1. A camera mount is provided and includes a hook and loop fastener member 104 for interengagement with the other of a hook or loop fastener member (not shown) secured to a camera. A pair of elastic loops 105 are provided to provide further securement for the camera to the fastener member 104 and the device 101. A trifold pouch 107 with three panels is provided with fold over straps 108 having hook and loop fastener elements to secure the straps to one another and to pouch 107. Buckle portions 110 are secured to the panel 102 as with webbing loops 111 and can be releasably coupled to the buckle portions 34 to ensure mounting of the device 101 to the jacket 3.

The above described vest utilizes numerous means to close the vest for use and attachment of items, e.g., the closure devices 90 and straps 43, loops 96 and associated locking zipper pulls 93, loops 96 and buckles 34 and associated fastener elements 47. A plurality of handles 26 and a plurality of loops 28 also provide redundancy for lifting. These structures provide redundant security in use of the vest 1.

It is also recognized and anticipated that the top and bottom members 4 and 8 can be used and configured for a wide variety of different types of applications such as carrying surveillance equipment, detectors, air samplers, transmitters and/or receivers, load carriage applications such as sewn and modular pouches including use of the MOLLE System, and for search and rescue applications. Depending upon the particular application and the type of equipment to be carried, the top and bottom members 4 and 8 and/or any one or more their associated panels 5, 6 and 7 can be configured and adapted to hold and carry such equipment. In this regard, different top members 4 and different bottom members 8 can be constructed depending upon the particular application desired and such different top and bottom members 4 and 8 can be easily interchangeable with other top and bottom members so as to achieve the desired application.

Still further, the bottom member 8 can likewise be constructed for different applications such as for high visibility applications (bright orange or other colored panels for visibility and identification purposes), flotation applications, load carriage configurations as previously mentioned, and armor applications wherein the bottom member 8 is constructed so as to hold and carry soft and/or hard armor. In cases where soft and/or hard armor are not necessary, the bottom member 8 can be made of a material which would be stab and cut proof thereby resisting sharp objects which may attempt to penetrate the present vest during field operations or if the animal is assaulted with a sharp object such as a knife. Still further, the bottom member 8 could be configured for weight and/or strength conditioning of the canine or other animal to which it is attached such as training greyhound dogs for racing, and other conditioning applications. Still further, the bottom member 8 can be adapted to achieve a cooling or warming application for the animal based upon the structure and type of material used and the climate in which the canine or other animal will be exposed during operations. This could include special materials and fabrics which could be heated and/or cooled prior to installing the vest on the particular animal. Other applications are likewise envisioned. Regardless of the particular application, the top and bottom members are interchangeable with each other and with other top and bottom members so as to adapt the overall vest for a particular application depending upon the mission involved.

Still further, it is likewise recognized and anticipated that the present vest 1 can be utilized on a wide variety of other animals outside of the canine family such as cats, horses, mules, donkeys and other similar animals. In this regard, the present vest is not limited to the canine species and can be made larger and/or smaller. Other uses are likewise envisioned.

Thus, there has been shown and described several embodiments of a novel invention. The terms “having” and “including” and similar terms as used in the foregoing specification are used in the sense of “optional” or “may include” and not as “required”. Many changes, modifications, variations and other uses and applications of the present invention will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

1. A vest for use on a canine, the vest comprising:
a jacket including a top panel portion, side panel portions and a lower panel portion and first and second longitudinally extending edge portions, said jacket having a neck opening and a tail opening with the first and second edge portions extending therebetween;
a closure device having first and second elongate portions adapted for selective engagement with one another, said first elongate portion being secured to the jacket adjacent the first edge portion and the second elongate portion being secured to the jacket adjacent the second edge portion; and
an expander panel having elongate side edges and third and fourth elongate portions of a said closure device each selectively interengageable with a respective said first or second said elongate portion to removably attach said expander panel to at least one of said panel portions and whereby disengagement of at least two of the elongate portions provides an access opening extending between the neck opening and the tail opening.

2. The vest of claim 1 wherein the edge portions being in the top panel portion.

3. The vest of claim 1 wherein one said edge portion being a portion of the top panel portion and another said edge portion being a portion of a said side panel portion.

4. The vest of claim 1 including a pair of said expander panels, said top panel portion including a pair of said edge portions and each said side panel portion having a respective said edge portion, and a said respective expander panel being removably attached between a respective said top panel edge portion and a respective said side panel edge portion.

5. The vest of claim 1 wherein the first, second, third and forth elongate portions including zipper runs.

6. The vest of claim 4 wherein the zipper runs being toothed zipper runs.

7. A vest for use on a canine, the vest comprising:
a top member including an upper panel portion and having a pair of first side edges extending generally longitudinally of the top member;
a bottom member having a lower panel portion and a pair of side panel portions, each said side panel portion having a second side edge adjacent a respective said first side edge, the top member and bottom member forming a jacket having a neck opening and a tail opening and defining a longitudinally extending body cavity; and
a pair of first closure devices, each closure device having at least two elongate portions adapted for selective engagement with one another wherein one said elongate portion being connected to the top member adjacent a said first side edge and another said edge portion being connected to the bottom member adjacent a respective said second side edge and when one said elongate portion is not engaged with its respective elongate portion said closure device provides a longitudinally extending opening for mounting the vest on a canine and for removal of the vest from a canine.

8. The vest of claim 7 wherein the closure devices including zippers and the elongate portions including zipper runs.

9. The vest of claim 8 wherein the zippers including toothed zippers.

10. The vest of claim 8 wherein the zippers including locking zipper pulls.

11. The vest of claim 8 wherein the zippers including zipper pulls with a loop secured to at least one of the zipper pulls and the vest including securement means adapted for extending through a respective said loop for releasably securing the respective said zipper pull in a zipper closed portion.

12. The vest of claim 7 including at least one first attachment device on the top member adapted for releasably attaching an auxiliary item to be carried by the vest.

13. The vest of claim 7 including first and second handles connected to at least one of the top member and bottom member with the first handle being positioned adjacent the neck opening and the second handle being positioned adjacent the tail opening.

14. A vest for use on a canine, the vest comprising:
a top member including an upper panel portion and having a pair of first side edge portions extending generally longitudinally of the top member on first and second sides of the top member;
a bottom member having a lower panel portion and a pair of side panel portions each on a respective side of the vest, each said side panel portion having a second side edge portion on first and second sides of the bottom member, a said first and second side edge portion being on one said side of the vest and a said first and second side edge portion being on an opposite said side of the vest;
first and second expander panels each having third and fourth side edge portions, said first expander panel being on one said side of the vest with its third and fourth side edge portions each being positioned adjacent a respective said first or second side edge portion, and said second expander panel being on the opposite side of the vest with its third and fourth side edge portions being positioned adjacent a respective said first or second side edge portion; and
a plurality of closure devices having elongate portions each secured to a respective one of the top member, bottom member and expander panels adjacent a respective first or second side edge portion or a respective third or fourth side edge portion, said adjacent closure device elongate portions being interengageable to removably secure the expander panels to the top and bottom members.

15. The vest of claim 14 wherein the closure devices including zippers and the elongate portions including zipper runs.

16. The vest of claim 15 wherein the zippers including toothed zippers.

17. The vest of claim 15 wherein the zippers including locking zipper pulls.

18. The vest of claim 1 15 wherein the zippers including zipper pulls with a loop secured to at least one of the zipper pulls and the vest including securement means adapted for extending through a respective said loop for releasably securing the respective said zipper pull in a zipper closed position.

19. The vest of claim 14 including at least one first attachment device on the top member adapted for releasably attaching an auxiliary item to be carried by the vest.

20. A vest for use on a canine, the vest comprising:
a jacket including a top panel portion, side panel portions and a lower panel portion and first and second longitudinally extending edge portions, said jacket having a neck opening and a tail opening with the first and second edge portions extending therebetween;
a closure device having first and second elongate portions adapted for selective attachment with one another, said first elongate portion being secured to the jacket adjacent the first edge portion and the second elongate portion being secured to the jacket adjacent the second said edge portion; and
at least one securement device secured to the jacket, said securement device having a coupling device for selectively coupling portions of the securement device together and bridging the closure device providing redundant securement together of portions of the jacket on opposite sides of the closure device.

21. The vest of claim 20 wherein the securement device including at least one strap portion and the coupler permitting selective release of the strap portion from a securement configuration permitting opening of the jacket along the closure device by detaching the first elongate portion from the second elongate portion.

22. The vest of claim 21 wherein the coupler including a buckle.

23. The vest of claim 21 wherein the closure device including a zipper.

24. The vest of claim 21 including an expander panel having a said first elongate portion and a said second elongate portion thereon each attached to a respective first and second elongate portion of the closure device.

25. The vest of claim 24 wherein the first and second elongate portions including zipper runs.

26. The vest of claim 21 wherein there being a plurality of said securement devices with one being adjacent the neck opening, one being adjacent the tail opening and one being positioned intermediate the neck and tail openings.

27. The vest of claim 26 wherein each of the securement devices bridging the closure device.

28. A vest for use on a canine, the vest comprising:
a jacket including a top panel portion, side panel portions and a lower panel portion and first and second longitudinally extending edge portions, said jacket having a neck opening and a tail opening with the first and second edge portions extending therebetween;
a closure device having first and second elongate portions adapted for selective attachment to one another, said first elongate portion being secured to the jacket adjacent the first edge portion and the second elongate portion being secured to the jacket adjacent the second said edge portion; and
an attachment device attached to the jacket and adapted for releasably attaching an auxiliary item to be carried by the vest.

29. The vest of claim 28 wherein the attachment device including one of a hook and loop member secured to the top panel portion.

30. The vest of claim 29 wherein there being a plurality of said attachment devices with said attachment devices including an elastic loop.

31. The vest of claim 29 including a carrier member releasably secured to the attachment device hook or loop member and having a second hook or loop member on an outer surface for releasably securing an auxiliary item to the vest.

32. The vest of claim 31 including a securement device having portions secured to the jacket and the carrier member and a coupling device having a portion secured to one of the securement device portions and operable to releasably couple the securement device portions together.
